(19) United States
(12) Patent Application Publication
(10) Pub. No.: US 2015/0318690 A1
(43) Pub. Date: Nov. 5, 2015

(54) SUBMODULE FOR LIMITING A SURGE CURRENT

(71) Applicant: SIEMENS AKTIENGESELLSCHAFT, München (DE)

(72) Inventors: HANS-GUENTER ECKEL, ROSTOCK (DE); HERBERT GAMBACH, UTTENREUTH (DE); FRANK SCHREMMER, FUERTH (DE); MARCUS WAHLE, FUERTH (DE)

(73) Assignee: SIEMENS AKTIENGESELLSCHAFT, MUENCHEN (DE)

(21) Appl. No.: 14/650,913

(22) PCT Filed: Dec. 10, 2012
(86) PCT No.: PCT/EP2012/074916

§ 371 Date: Jun. 10, 2015

(51) Int. Cl. H02H 9/02; H02M 7/537

(52) U.S. Cl. CPC H02H 9/02; H02M 7/537

(57) ABSTRACT

A submodule for a modular multistage converter contains a first and a second connection terminal, an energy store, and a power semiconductor circuit which is connected to the energy store such that the voltage dropping at the energy store can be generated at the connection terminals in a first switch state and a zero voltage can be generated at the connection terminals in a second switch state. The aim is to provide such a submodule which allows an inexpensive submodule housing to be used while maintaining the same energy storage capacity or which allows an increased energy storage capacity while using the same housing without thereby undermining the protection provided by the submodule housing. This is achieved in that the power semiconductor circuit is connected in parallel to an energy storage branch in which the energy store and a device for limiting a surge current are arranged.

The invention relates to a submodule for a modular multi-stage inverter with a first and second connecting terminal, an energy store and a power semiconductor circuit connected to the energy store in such a way that in a first switch state the voltage dropped across the energy store can be generated at the connecting terminals and in a second switch state a zero voltage can be generated at the said connecting terminals.

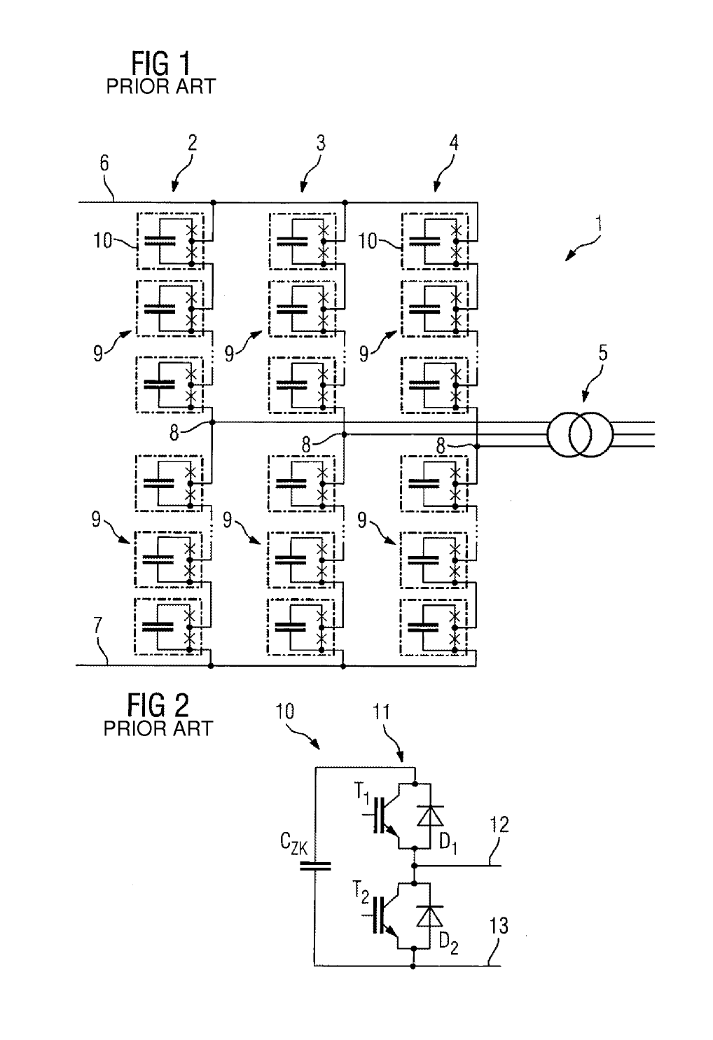

Such a submodule is, for example, already known from DE 101 03 031 B4. The inverter described there is illustrated here once again in FIG. 1. It can be seen that the inverter 1 comprises three phase modules 2, 3 and 4, each of which extends between two DC terminals 6 and 7 of different polarities. Each of the phase modules moreover comprises an AC terminal 8. An AC power network, not further illustrated in the figure, is connected through a transformer 5 to the AC terminal 8. A phase module path 9 extends between the AC terminal 8 and each DC terminal 6 and 7 of each of the submodules, wherein a series circuit of two-pole submodules 10 is arranged in each phase module path 9.

The topology of the submodules 10 is illustrated in more detail in FIG. 2. It can be seen that each submodule 10 includes an energy store 11 in the form of a single-pole intermediate circuit capacitor C_{ZK}. The intermediate circuit capacitor C_{ZK} is connected in parallel with a series circuit 11 consisting of two power semiconductor switches T₁ and T₂ which are connected in series and can be switched on and off. Freewheeling diodes D₁ and D₂ are here connected in opposite senses in parallel with each of the power semiconductor switches T₁ and T₂. The potential node located between the power semiconductor switches T₁ and T₂ is connected to a first connecting terminal 12, wherein the other connecting terminal 13 of the submodule 10 is connected directly to one pole of the energy store C_{ZK}. The power semiconductor switches T₁ and T₂ can be switched on and off via control lines, not illustrated, on what is known as their gate terminal, so that the submodule 10 can be switched back and forth between different switch states. In a first switch state, in which, for example, the power semiconductor switch T₁ is switched on while the power semiconductor switch T₂ is however switched off, the voltage present at the energy store C_{ZK} appears at the submodule connection terminals 12 and 13. In the converse case, the second switch state, the submodule connection terminals 12 and 13 are connected together conductively through the switched-on power semiconductor switch T₂, so that a zero voltage is dropped across the submodule connection terminals 12, 13.

If both the power semiconductor switches T₁ and T₂ of a submodule according to FIG. 2 fail, the result is what is known as a “direct short”, in which the energy store C_{ZK} discharges into the fault location. Only the parasitic inductances limit the rise in current, which can reach values of several hundred kiloamps. Currents of this magnitude can cause serious damage. The housing of the power semiconductor switches can therefore, for example, burst, and explosive gases resulting from an arc can be created. The destruction of one submodule can, moreover, damage neighboring submodules, so creating the risk of a chain reaction. For this reason, it is provided according to the state of the art, that the power semiconductor switches T₁ and T₂, together with their respective freewheeling diodes D₁ and D₂, are to be arranged in a submodule housing that is capable of shielding the surrounding environment from flying parts and explosion gases. It is expedient here to choose a value for the capacitance of the energy store of the submodule sufficiently small that the strength of the housing is sufficient in the event of a fault. This criterion does, however, limit the total power capacity of an inverter, since higher inverter power also requires the energy stores to have a greater capacitance, or, in other words, a larger intermediate circuit capacitor.

The object of the invention is therefore to provide a submodule of the type described above which allows an economical submodule housing while still having the same energy storage capacity or which, with a given housing, features a comparatively raised energy storage capacity without thereby undermining the protection provided by the submodule housing.

The invention achieves this object in that the power semiconductor circuit has an energy storage path connected in parallel with it in which the energy store and the means of current pulse limitation are arranged.

According to the invention, means of current pulse limitation, which lower the intensity of a current pulse during a discharge of the energy store in the event of a fault, are arranged in the submodule. For this purpose, the means of current pulse limitation are arranged in series with the energy store. They exhibit the property that they lower the discharge currents arising during a sudden discharge of the energy store, for example in the presence of a short circuit. The capacitance of the energy store can therefore be increased without creating the risk of destroying the submodule housing. It is, of course, also possible in the context of the invention for the housing to be of a less strong design if the capacitance of the energy store does not have to be increased to meet the requirements, but rather remains constant.

Means of commutation are, moreover, advantageously provided, and support a commutation of the currents flowing through the submodule when the switch state of the power semiconductor circuit changes. The means of commutation are appropriate for circumstances in which, as a result of the means of current pulse limitation connected in series with the energy store, a low-inductance commutation circuit is no longer present for the switch processes induced during operation. The means of commutation support the said commutation, so that a normal switching of the submodule is possible, safely and rapidly, in spite of the means of current pulse limitation. Different variants for implementing the means of commutation are conceivable, and will be considered even further below.

Advantageously the power semiconductor circuit is a series circuit comprising two power semiconductor switches that can be switched on and off, wherein the first connecting terminal is connected to the potential node between the power semiconductor switches, and the second connecting terminal is connected directly to the energy storage path. According to this advantageous implementation of the invention, the second connecting terminal is either connected through the means of current pulse limitation to the energy store, or is connected directly to a pole of the energy store. Expressed otherwise, in the second variant the second connecting terminal is connected to the means of current pulse limitation via the energy store. According to this advantageous further development of the submodule illustrated in FIG. 2, it is ensured that the means of current pulse limitation can develop their effect in what is known as a half-bridge circuit.

According to a preferred embodiment of the invention, the means of current pulse limitation are implemented as a choke, fusible link and/or resistor. The resistor can be a linear resistor or a non-linear resistor. If only a fusible link is used as a means of current pulse limitation it is to be implemented as a high-voltage component, and is therefore correspondingly designed to be space-consuming. The parasitic inductances occurring in the event of a flow of current through the fusible link ensure a sufficient degree of current pulse limitation until, at the end of the melting process, the fusible link finally interrupts the flow of current. For currents that are not too large, the fusible link provides a low-inductance commutation path. The fusible link is therefore at the same time a means of commutation.

Expediently the means of commutation comprise a commutation capacitor connected with low inductance to the power semiconductor circuit, and connected in parallel with the energy storage path. The commutation capacitor has a significantly lower capacitance than the energy store which is, for example, an intermediate circuit capacitor. It merely provides the conditions for creating a fast commutation of the currents when the power semiconductor circuit switches.

Advantageously the means of commutation comprise a resistor which is arranged in parallel with the means of current pulse limitation in the energy storage path. The resistor is arranged in parallel with the means of current pulse limitation, for example in parallel with a choke, and when appropriately designed also alone create the conditions necessary for the commutation. Preferably the said resistor is however used together with a commutation capacitor connected with low inductance to the power semiconductor circuit.

It is moreover possible for the means of commutation to comprise a diode that is arranged in parallel with the means of current pulse limitation in the energy storage path. It is again true here that the diode can be employed either with or without an additional commutation capacitor.

Advantageously the means of commutation comprise a snubber capacitor that is arranged in parallel with the means of current pulse limitation in the energy storage path. The snubber capacitor can be arranged either in parallel with the means of current pulse limitation, for example with a choke, or with a diode and/or with a resistor.

The invention also relates to an inverter path for a modular multi-stage inverter comprising a series circuit of two-pole submodules of the type mentioned above.

The invention moreover also comprises an inverter that is fitted with such inverter paths.

Further expedient embodiments and advantages of the invention are objects of the following description of exemplary embodiments of the invention with reference to the figures of the drawing, wherein the same reference signs refer to components having the same effect, and where

FIG. 1 shows an exemplary embodiment of a modular multi-stage inverter according to the state of the art,

FIG. 2 shows a submodule for a modular multi-stage converter according to FIG. 1,

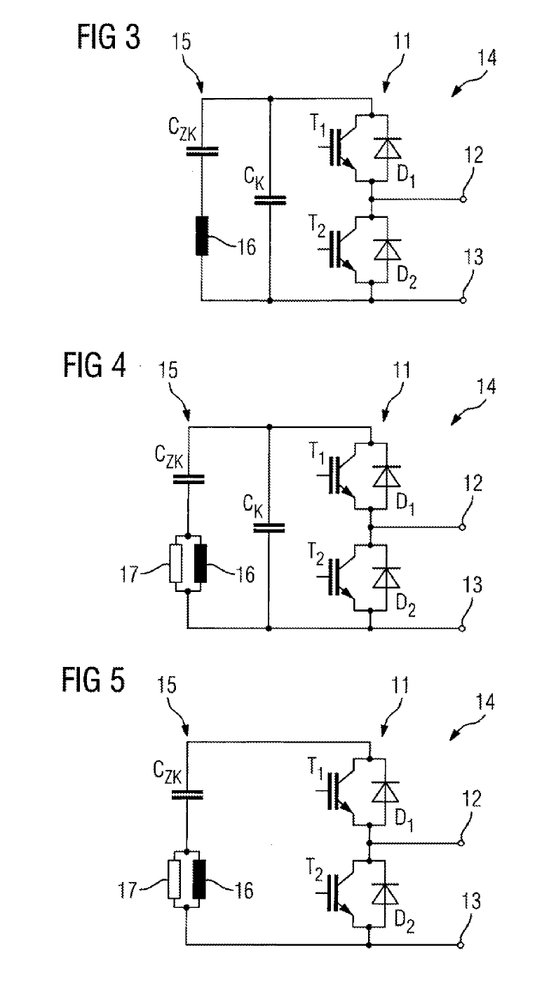

FIG. 3 shows an exemplary embodiment of a submodule according to the invention,

FIG. 4 shows an exemplary embodiment of a submodule according to the invention,

FIG. 5 shows an exemplary embodiment of a submodule according to the invention,

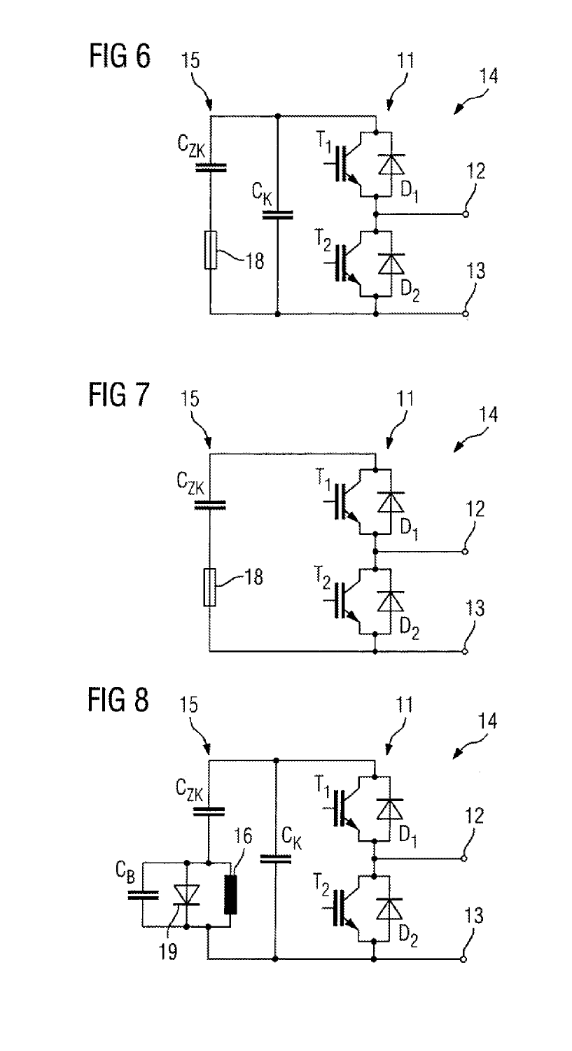

FIG. 6 shows an exemplary embodiment of a submodule according to the invention,

FIG. 7 shows an exemplary embodiment of a submodule according to the invention,

FIG. 8 shows an exemplary embodiment of a submodule according to the invention, and

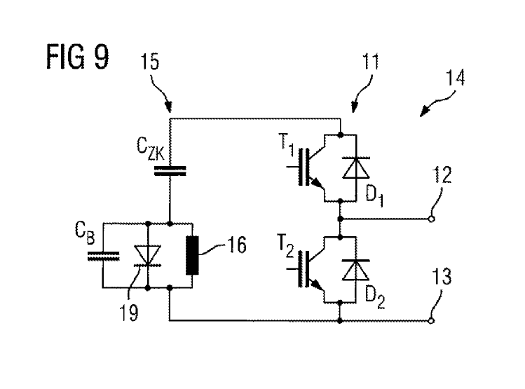

FIG. 9 shows an exemplary embodiment of a submodule according to the invention.

FIG. 1 and FIG. 2 were already treated in connection with the state of the art that was explained extensively above.

FIG. 3 shows a submodule 14 largely corresponding, in terms of the design of the power semiconductor circuit, to the submodule 10 already known illustrated in FIG. 2. Thus the submodule 14 according to FIG. 3 also comprises a series circuit 11 of two power semiconductor switches T₁ and T₂, both of which are shown here as IGBTs. It is of course also entirely possible within the scope of the invention for other power semiconductor switches, such as GTOs or IGCTs' that can be switched on or off to be utilized here. Each of the power semiconductor switches T₁ and T₂ has a freewheeling diode D₁ or D₂ connected in opposite senses in parallel with it. A first connecting terminal 12 is connected to the potential node between the power semiconductor switches T₁ and T₂. The second connecting terminal 13 is however not—as in FIG. 2—connected directly to a pole of the energy store. Rather, the submodule 14 according to FIG. 3 comprises an energy storage path 15, in which the energy store, in the form of an intermediate circuit capacitor C_{ZK} and a choke 16 as a means of current pulse limitation are arranged in series. The second connecting terminal is connected via the choke 16 to the energy store C_{ZK}, and thus is located directly on the energy storage path 15. In order to ensure reliable commutation of the currents when the power semiconductor switches T₁ and T₂ are switched, a commutation capacitor C_{K} is provided, which is arranged in parallel with the power semiconductor switch 11 and in parallel with the energy storage path 15. The commutation capacitor C_{K} here is connected directly, i.e. with low inductance, to the power semiconductor circuit 11, here consisting of the series connection of T₁ and T₂. It has a significantly smaller capacitance than the intermediate circuit capacitor C_{ZK}. As a result of the choke 16, in the event of a spontaneous discharge caused by failure of the power semiconductor switches T₁ and T₂, high current pulses through the choke 16 are avoided. At the same time the commutation capacitor C_{K} ensures reliable commutation of the switching currents.

FIG. 4 shows a further exemplary embodiment of the submodule according to the invention, differing from the exemplary embodiment shown in FIG. 3 in that the means of commutation comprise, in addition to the commutation capacitor C_{K}, a resistor 17 connected in parallel with the choke 16 in the energy storage path 15. The ohmic resistor 17 makes it possible also for currents with high frequency, for example during transient processes, to be able to flow through the energy storage path 15. The ohmic resistor 17 supports the commutation in this way.

If the resistor 17 is appropriately selected, the commutation capacitor C_{K}, which is connected with low inductance to the power semiconductor circuit 11, can be omitted. This exemplary embodiment is illustrated in FIG. 5.

FIG. 6 shows a further exemplary embodiment of the invention that corresponds to that of FIG. 3, wherein however instead of a choke 16, a fusible link 18 is employed in the energy storage path 15 as a means of current pulse limitation. As was already described further above, the fusible link 18 is designed for the high voltage, and thus is to be understood as a space-consuming component. It therefore has an inductance that is large enough to effectively dampen current pulses. The commutation capacitor C_{K}, which is connected with low inductance to the power semiconductor circuit 11, again serves to permit a fast commutation.

FIG. 7 shows an exemplary embodiment according to FIG. 6, wherein however the commutation capacitor is omitted. In spite of its parasitic inductance, the fusible link provides adequate commutation when switching T₁ and T₂ if currents are small.

In place of the fusible link in FIG. 6 and FIG. 7, it is also possible to use a resistor, or a power rail acting as a resistor, as the means of current limitation. Preferably this resistor is a non-linear resistor with a non-linear characteristic, such that at low current it exhibits a low resistance value and a high resistance value at high currents. Alternatively it is also possible to use a resistor whose resistance value has a positive temperature coefficient.

In the exemplary embodiment according to FIG. 8, the means of commutation comprise a diode 19 arranged in parallel with the choke 16 in the energy storage path 15. A snubber capacitor C_{B} is also provided, which again supports the commutation. The snubber capacitor C_{B} has an even smaller capacitance than the commutation capacitor C_{K}, and a very much smaller capacitance than the intermediate circuit capacitor C_{ZK}.

In an exemplary embodiment of the invention not illustrated in the figures, the snubber capacitor C_{B} is omitted. The means of commutation comprise merely the diode 19 connected in parallel with the choke 16 in the energy storage path 15, as well as a commutation capacitor C_{K}, connected, with low inductance, to the series circuit 11 of the power semiconductor circuit T₁ and T₂.

FIG. 9 shows a further exemplary embodiment of the invention corresponding largely to the exemplary embodiment illustrated in FIG. 8, wherein however the commutation capacitor C_{K} is omitted. The means of commutation therefore comprise merely the diode 19 and the snubber capacitor C_{B}. The diode 19 moreover exhibits a forward direction that is in the opposite direction to that of the freewheeling diodes D1 and D2.

1-10. (canceled)

11. A submodule for a modular multi-stage inverter, the submodule comprising:
connecting terminals including a first connecting terminal and a second connecting terminal;
an energy storage path having a energy store and means for current pulse limitation disposed therein; and
a power semiconductor circuit connected to said energy store such that in a first switch state a voltage dropped across said energy store being generated at said connecting terminals and in a second switch state a zero voltage being generated at said connecting terminals, said power semiconductor circuit connected in parallel with said energy storage path.

12. The submodule according in claim 11, further comprising means of commutation for enabling a low-inductance commutation when a switch state of said power semiconductor circuit changes.

13. The submodule according to claim 11, wherein said power semiconductor circuit includes a series circuit of two power semiconductor switches that can be switched on and off, wherein said first connecting terminal is connected to a potential node between said power semiconductor switches, and said second connecting terminal is connected directly to said energy storage path.

14. The submodule according to claim 11, wherein said means for current pulse limitation are implemented as a choke, a fusible link and/or a resistor.

15. The submodule according to claim 12, wherein said means of commutation includes a commutation capacitor connected with low inductance to said power semiconductor circuit and disposed in parallel with said energy storage path.

16. The submodule according to claim 12, wherein said means of commutation contains a resistor disposed in parallel with said means for current pulse limitation in said energy storage path.

17. The submodule according to claim 12, wherein said means of commutation contains a diode disposed in parallel with said means for current pulse limitation in said energy storage path.

18. The submodule according to claim 12, wherein said means of commutation includes a snubber capacitor disposed in parallel with said means for current pulse limitation in said energy storage path.

19. An inverter path for a modular multi-stage inverter, the inverter path comprising:
a series circuit of two-pole submodules, each of said two-pole submodules containing:
connecting terminals including a first connecting terminal and a second connecting terminal;
an energy storage path having a energy store and means for current pulse limitation disposed therein; and
a power semiconductor circuit connected to said energy store such that in a first switch state a voltage dropped across said energy store being generated at said connecting terminals and in a second switch state a zero voltage being generated at said connecting terminals, said power semiconductor circuit connected in parallel with said energy storage path.

20. An inverter, comprising: inverter paths according to claim 19 and connected together in a bridge circuit.
